(19) United States
(12) Patent Application Publication
(10) Pub. No.: US 2003/0031853 A1
(43) Pub. Date: Feb. 13, 2003

(54) Laminated composite sheet metal capable of being shaped, method for making same and resulting motor vehicle body parts

(76) Inventors: Michel Sanadres, Pont Sainte Maxence (FR); Philippe Charbonnet, Chamant (FR)

Correspondence Address: SUGHRUE MION, PLLC, 2100 PENNSYLVANIA AVENUE, N.W., WASHINGTON, DC, 20037, US

(21) Appl. No.: 10/203,200

(22) PCT Filed: Feb. 15, 2001
(86) PCT No.: PCT/FR01/00447

(30) Foreign Application Priority Data
Feb. 18, 2000 (FR) 0001988

(51) Int. Cl. B32B 25/02

(52) U.S. Cl. 428/295.1; 428/296.7

(57) ABSTRACT

The invention concerns a laminated composite sheet metal capable of being shaped comprising two metal sheet skins linked by a core formed with at least a coat based on polymer materials including at least a continous textile web of polymer fibres impregnated with at least a polymer material for impregnating the web and adhering with said skins. The invention is characterized in that said polymer fibres are thermoplastic, said impregnating and adhering polymer material is thermoset. The invention also concerns a method for making said sheet metal and resulting motor vehicle body parts.

The invention relates to a formable laminated composite panel comprising two sheet metal facings joined by a layer based on a polymer material forming the core of the composite panel and to a process for manufacturing this panel and the use of a composite panel of this type for producing sheet parts formed, for example, by drawing, bending or profiling, and then painted.

In general, the main advantage of laminated composite panels over conventional metal sheets resides in the weight saving that can be obtained when producing parts having predetermined mechanical strength specifications; this advantage is very important in automobile applications.

U.S. Pat. No. 3 382 136 (Union Carbide) discloses composite panels of the aforementioned type, the core of which is made of a thermoplastic chosen from the group comprising polyolefins, polyamides, polyhydroxyethers, polycarbonates, vinyl polymers, such as polystyrenes, polyacrylics, polymethacrylics or polyvinyl chloride.

This document indicates that such composite panels are much easier to form by bending than sheets of the same plastic without facings.

Patent application EP 108 710 (Ciba-Geigy) also discloses composite panels of the aforementioned type, the core of which is made of a thermoplastic chosen from the group comprising blends of propylene-ethylene copolymers and propylene-unsaturated carboxylic acid copolymers, and, optionally, polyolefins such as polypropylene, polyethylene, polybutylene, polyiso-butylene and/or polymethylpentene; the thermoplastic may contain:

fillers such as talc or calcium carbonate;

reinforcing means such as glass fibers, carbon fibers or mica platelets;

conventional additives for polymer materials, such as stabilizers and antioxidants.

The composite panel disclosed in that document is essentially intended for electrical applications and no forming operation on this panel is envisaged in that document.

Patent EP 184 549 (Schweizerische Aluminium) also discloses panels of this type, the polymer core of which is reinforced with fibers, such as glass fibers or carbon fibers (page 2, lines 57-60).

U.S. Pat. No. 3 721 597 (Dow) discloses composite panels, the core of which is laminated as three sublayers: an inner sublayer made of a thermoplastic, such as a high-density polyethylene, placed between two outer sublayers made of an adhesive thermoplastic, such as an ethylene/acrylic acid copolymer. The melting point of the inner sublayer must be at least 14° C. higher than that of the outer sublayers in order to prevent the inner sublayer from melting at the time of colamination and assembly by thermally bonding the laminated composite panel.

According to that document (column 6, line 63 to column 7, line 6 — example IV), the inner sublayer may also be in the form of a woven or nonwoven textile web, composed of thermoplastic fibers, such as Nylon™ 66.

Patent PT 67259 (Solvay) also discloses panels of this type (claim 9), the core of which consists of a modified polyolefin sheet comprising between 10 and 90% of cellulose fibers. According to that document, with this type of fiber, better adhesion between the polyolefin sheet and the metal facings is obtained. Preferably, the polyolefin material is itself in the form of polyolefin fibers (claim 7) so that the core is then a textile web integrating polyolefin fibers and cellulose fibers.

Patent application JP 62-019456 (Matsushita Electric Works) discloses a laminated composite panel of the aforementioned type, the core of which has at least three sublayers: a central sublayer based on a thermoplastic resin having a high temperature withstand, inserted between two outer sublayers comprising at least one preimpregnated textile web. The laminated composite panel described here is intended for electronic applications of printed-circuit substrates and is not suitable for a forming operation.

Patent FR 1 579 770 (Reichold Beckacite) also discloses a laminated composite panel of the aforementioned type, the core of which is formed from a woven or nonwoven web, for example of glass fibers or synthetic fibers, the web being preimpregnated with a curable polyester resin. The panel obtained is intended for the building industry and is not suitable for a forming operation.

Patent application AU 8941110 (Symonds R, Australia) discloses panels of the aforementioned type, the core of which consists of porous fibrous sheets preimpregnated with a curable resin which serves to give the core its cohesive and adhesive properties after applying a heating cycle. The fibrous sheets are not textile webs and the panel obtained is not suitable for a forming operation.

For the purpose of improving the drawing formability of the panels of the aforementioned type, patent application EP 115 103 (Sumitomo) also discloses composite panels whose core is also laminated as three sublayers, the two outer sublayers of which have the feature of being ductile and of not having a yield point on the stress-strain curve; for these outer sublayers of the core, it is possible to use, for example, nitrile rubber, chlorosulfonated polyethylene or polyurethane.

The laminated composite panels disclosed in the documents cited above are not well suited for producing formed and painted automobile body parts, particularly when the operation of painting these parts includes a heat treatment step for drying and/or baking the paint at temperatures of around 160° C.

The process for manufacturing such a part generally comprises the following steps:

forming, especially by drawing, the laminated composite panel;

applying paint to the surface of the formed part;

baking the paint applied to the part under thermal conditions suitable for crosslinking the binder of said paint.

A conventional method of applying at least one of the paint coats is electrodeposition in a cataphoresis bath. However, paints that can be applied by cataphoresis generally require baking at temperatures above 160° C. and possibly up to 220° C. However, at these temperatures, the polymer material of the core of the laminated composite panel generally starts to creep, or even flow, so that the painted part obtained after baking exhibits defects unacceptable for its end use.

In the case of applying powder paint or paint in solution, the same temperature withstand problem arises when the baking exceeds 160° C.

Thus, the poor withstand of the laminated composite panels of the aforementioned type to heating cycles during which the temperature exceeds 160° C. considerably limits the development of these panels in the automobile field.

Patent application JP 62 264941 (Nippon Steel) discloses a laminated composite sheet whose core is based on polypropylene containing less than 60% of fibrous fillers. According to that document, this panel is well suited to the manufacture of painted automobile body parts thanks to good drawability and heat resistance compatible with drying after painting. The fiber-filled polymer material of the core has a melt flow index of 0.01 to 0.6 g/10 min at 190° C., measured according to JIS 6758 standard.

To improve the dimensional and thermal stability of the parts formed from laminated panels of this type, patent EP 547 664 (Hoogovens) discloses a forming process in which, before drawing, the composite panel is preheated between the ISO/A temperature and the Vicat B temperature of the core material of the panel.

The object of the invention is to provide a solution to the poor withstand behavior of parts made of laminated composite panels of the aforementioned type to heating cycles during which the temperature exceeds 160° C.

For this purpose, the subject of the invention is a formable laminated composite panel comprising two sheet metal facings joined by a core formed by at least one layer based on polymer materials, comprising at least one continuous textile web of polymer fibers which is impregnated with at least one polymer material for impregnation of the web and for adhesion to said facings, characterized in that:

said polymer fibers are thermoplastic;

said impregnation and adhesion polymer material is a thermoset.

The term “continuous textile web” is understood to a mean a woven or nonwoven web extending over the entire surface of the core; preferably, the web is nonwoven in order to avoid any risk of marking by transferring a texture onto the facings during forming operations.

Preferably:

the continuous textile web has a tensile elongation at break greater than that of the sheet metal facings, preferably greater than 80%;

the textile web is needle-punched;

the weight of the impregnation thermoset advantageously represents between 10 and 90%, in particular between 30% and 70%, of the total weight of the core;

the core has a uniform thickness of greater than 0.1 mm and a density greater than 0.5 kg/dm³ , thereby allowing it to be clearly distinguished from insulating panels for buildings, generally having a core made of polyurethane foam;

the facings are made of sheet steel.

Thanks to the continuous textile web and the impregnation thermoset, the temperature withstand of the composite panel is very substantially improved. Thanks to the thermoplastic nature of the fibers of this web, the composite panel is easy to form, for example by bending, drawing or profiling. Thanks to the metal facings and to the low porosity of the core, the composite panel has good mechanical properties, especially for use in manufacturing body parts. Thanks to the large thickness that the core may have, the body parts obtained may be lighter, for equivalent mechanical properties, than conventional body parts made of sheet steel.

The subject of the invention is also a process for using the panel according to the invention for manufacturing automobile body parts. This method comprises the following steps:

forming a part made of laminated composite panel;

applying paint to the surface of the formed part;

baking the paint applied to the part under thermal conditions suitable for crosslinking the binder of said paint.

The forming is preferably carried out by drawing, bending or profiling. The panel according to the invention withstands severe drawing and/or bending and/or profiling conditions.

The paint may be applied, for example, by cataphoresis, by powder spraying or by coating with a liquid paint in solution or with a molten polymer layer. The panel according to the invention may be treated at temperatures above 160° C., preferably above 180° C., which temperatures are generally reached when baking the paint.

A better understanding of the invention will be gained on reading the description which follows, which is given by way of nonlimiting example.

The formable laminated composite panel according to the invention will firstly be described.

Each facing of the composite panel-according to the invention therefore consists of a metal sheet advantageously having a thickness of between 0.1 mm and 1.5 mm, preferably between 0.2 mm and 0.5 mm, for example about 0.25 mm. Preferably, steel sheets are chosen which have better mechanical properties than aluminum sheets and which are more easily drawable. These steel sheets may be bare, coated with a metal alloy, treated with a mineral compound, for example by chromatizing or phosphatizing, optionally oiled or coated with an organic material, such as a thin organic coating, a primer paint coat or even a lacquer finish.

Preferably, a needle-punched textile web is used, this denoting a web of the type obtained by fiber carding, calendering and then needle punching. The term “needle punching” is understood to mean an operation of embedding fibers, for example by mechanical or hydraulic means; this web therefore forms part of nonwoven textiles.

The textile webs that can be used for implementing the invention may also incorporate known compounds, in the form of powders or fibers, suitable for improving their stability or, for example, their electrical conductivity.

To implement the invention, it may prove advantageous to use a web having a mass per unit area of between 100 g/m² and 1500 g/m², preferably between 250 g/m² and 700 g/m² .

The thermoplastics of the fibers used for this web are preferably chosen from the group comprising polyolefins, such as polypropylene or polyethylene, polyesters, polyamides, polycarbonates, polyimides, polyacrylics, polymethacrylics or polyvinyl chlorides. These thermoplastics may incorporate conventional additives, such as mineral fillers or plasticizers.

As examples of needle-punched textile webs, mention may be made of the commercial products BESTER 30, TIMEX 40, TIMEX 60 or DUTEX 4140 THU from Tharreau and the commercial products PR200 and PR300 from Sommer; these textile webs made of thermoplastic fibers are commonly used for soil drainage in civil engineering.

The impregnation and adhesion polymer material, which is a thermoset, is prepared from one or more thermosetting resins. Within the context of the present invention, the term “thermosetting resin” is understood to mean a resin or a compound whose molecular weight can increase and which can crosslink under the action of heat or of another factor. Among these other factors, mention may be made, by way of nonlimiting example, of the action of water, the addition of catalysts, electron beam or UV irradiation, or else mixing with a hardener, as well as any other suitable process. Likewise, the term “thermoset” conventionally denotes a thermosetting resin that has been crosslinked without necessarily heating it.

This thermosetting resin is preferably chosen from the group comprising epoxy resins, phenolic resins, such as nitrile-phenolic resins and vinyl-phenolic resins, polyurethane resins, ketone-formaldehyde resins, urea resins, melamine resins, aniline resins, sulfonamide resins, alkyd resins, unsaturated polyester resins, polybutadiene resins, bismaleimide resins, polyvinyl butyral resins, isocyanate resins and polyimide resins.

Preferably, the thermoplastic of the fibers is based on polypropylene and the impregnation and adhesion polymer material is based on an epoxy resin.

This thermosetting resin may contain within it a number of chemical and/or metallic and/or mineral compounds so as to improve the processing or usage characteristics of the panel according to the invention:

the metallic compounds, such as zinc or nickel fillers or iron phosphide fillers, make it possible in particular to ensure electrical conductivity between the two metal sheets and thus favor the spot welding and painting operations which follow the forming operations;

the mineral compounds, such as talc, chalk, lime and silica fillers, make it possible in particular to improve the temperature withstand of the resin and likewise of the textile web during the painting operations that may follow the forming operations;

the chemical compounds, such as elastomeric fillers and/or thermoplastic fillers (polypropylene, polyethylene, polyamnide or other type), make it possible for the thermosetting resin to be made more ductile and tough and likewise for the forming performance and the mechanical properties of the composite panel according to the invention to be improved.

In a manner known per se, the thermosetting resin is chosen so as to obtain both good adhesion to the facings and good impregnation of the textile web. Depending on the impregnation method used, this thermosetting resin may be in the form of a paste, in the form of a molten liquid or a liquid in solution, or in the form of powder.

In certain cases, the panel according to the invention may include several types of thermosetting resins which differ in terms of chemistry, form, etc. Thus, it will be possible to use a first resin to allow good impregnation to the core of the textile and a second resin to improve the adhesion properties. It may also be envisioned to produce a preblend of these two resins before impregnating the textile web.

The core thus formed by at least one layer comprising at least one continuous textile web impregnated with the thermoset polymer has a thickness generally between 0.1 mm and 4 mm, preferably between 0.2 mm and 2 mm, for the production of automobile body parts.

In this core, the weight of the impregnation thermoset advantageously represents between 10% and 90%, preferably between 30% and 70%, of the total weight of the core.

The formable laminated composite panel according to the invention may be manufactured by any suitable process. Thus, the process may involve carrying out the following steps:

a textile web is impregnated using one or more thermosetting resins, each resin being applied in succession or else in one go by means of a resin blend prepared beforehand;

a metal sheet is applied to each side of the preimpregnated web;

the web, thus provided with its two sheet metal facings, undergoes a curing treatment suitable for crosslinking the thermosetting resin or thermosetting resins in order to form the thermoset; this treatment may be a thermal or other treatment.

However, the present inventors have found that it may be advantageous to proceed in a different manner. Thus, another subject of the invention consists of a process for manufacturing a formable laminated composite panel according to the invention, comprising:

precoating one side of at least one facing made of sheet metal using a material comprising at least one thermosetting resin; then

applying the precoated side of said sheet metal against a textile web optionally preimpregnated using one or more thermosetting resins; then

applying a second sheet metal facing, optionally precoated using a material comprising at least one thermosetting resin, against the other side of said textile web; and then

a treatment for curing the thermosetting resin or resins used, suitable for crosslinking the thermosetting resin or thermosetting resins in order to form the thermoset.

Thanks to this precoating step, the adhesion properties of the various components of the panel according to the invention may be optimized. This is because, during the contacting and bonding operations, this or these thermosetting resins applied beforehand to the metal sheets will not only ensure the adhesion properties of the textile web but will diffuse within the textile web and thus impregnate it to a greater or lesser extent. In certain cases, this precoating operation may completely substitute for the prior operation of impregnating the textile web, which textile web will therefore be used in the non-impregnated state.

The precoating may consist in coating with a thermosetting resin in the viscous state, which will then impregnate the textile web during application of the facing thereto.

It will also be possible to coat a facing with a blend comprising at least one thermosetting resin and at least one thermoplastic. This method of implementation has the advantage that, after coating the facing, it can be dried, causing the thermosetting material to crosslink and the thermoplastic to solidify. The facing thus coated can then be stored and then used when this is necessary. Before the facing is applied to the textile web, it will be sufficient to heat said facing in order to melt the thermoplastic, thereby making it possible to ensure that the facing adheres to the web.

A more detailed description will be given below of the steps that can be used in the process according to the invention or in another process allowing the panel according to the invention to be manufactured.

Step of preimpregnating the thermoplastic textile web with one or more thermosetting resins

unwinding of coils of textile web;

impregnation of this web by means of a device suitable for this purpose, for example by the use of roll coaters, spray processes or immersion or gravity-fed processes;

in the case of the use of liquid resins in solution, heating of the preimpregnated web so as to remove the solvents or water; this heating may help in the dimensional stabilization of the web. In certain cases, to facilitate the bonding operation, this preimpregnated web may be calendered before it is fully dried, thereby reducing its thickness before the next step is carried out;

wind-up of the web thus preimpregnated in the form of coils.

Step of applying the facings to both sides of the web, whether preimpregnated or not

A — Example of a batch process:

Unwinding and cutting of the coils of sheet metal into blanks;

possible precoating, with one or more thermosetting resins, of that side of the metal sheet that will be brought into contact with the textile web. This precoating is carried out by suitable devices, such as roll coat, spray, doctor blade, bead-coating devices, etc. To take an example, the amounts of thermosetting resins applied may vary between 10 and 400 g/m² and preferably between 50 and 200 g/m²;

unwinding and cutting of the coils of textile core into sheets, which may or may not be preimpregnated;

positioning of the textile core sheets between the two sheet metal blanks which may or may not be precoated;

compression of the assembly and application of the conditions suitable for the impregnation and adhesion thermosetting resin or resins to cure and possibly impregnate the textile web:

in the case of curing at room temperature, the storage times under pressure are generally between 12 hours and 7 days,

in the case of hot curing, the heating cycles generally have maximum temperatures between 60 and 200° C. and times ranging from 10 seconds to 60 minutes; a heating press is then used;

cooling of the formable laminated composite panels thus produced.

B — Example of a continuous process:

Unwinding of a coil of textile core which may or may not be preimpregnated between two coils of sheet metal, the unwinding speed being generally between 1 and 20 m/min;

unwinding of the coils of sheet metals as blanks, optionally followed by precoating of that side of the blanks that will be brought into contact with the textile web, this precoating being with one or more thermosetting resins. This precoating is carried out by suitable devices, such as roll coat, spray, doctor blade, bead-coating devices, etc. To take an example, the amounts of thermosetting resin applied may vary between 10 and 400 g/m² and preferably between 50 and 200 g/m²;

hot calendering of the core between the two metal sheets: temperature generally between 150 and 200° C., for times ranging from 3 to 300 seconds and preferably between 20 and 60 seconds;

cooling and winding into a coil of the strip of formable laminated composite panel obtained.

The main advantages of the formable laminated composite panel obtained are the following:

the thermoplastic textile core, optionally needle-punched, provides:

ductility and pliancy properties needed for the forming, for example bending, crimping, profiling and especially drawing, operations,

good ability to be impregnated with an organic resin, such as the adhesive material or materials based on thermosetting polymers, since the resin may easily diffuse and penetrate between the fibers of this textile,

economic advantages;

the adhesive material or materials based on thermosetting polymers provide:

good direct adhesion of the core to the metal, especially steel, sheets, whatever their surface finish (degreased, chromatized, oiled or prepainted),

good durability of the adhesion and cohesive properties of the core with respect to any attack from the external environment,

good mechanical properties in terms of stiffness of the panels and of the parts produced by forming these panels,

good ability to withstand the heating cycles of the panel-painting operations.

This is because the thermosetting resin or resins diffuse within the tangled thermoplastic fibers during the impregnation step or during the final heat treatment, and become fixed therein by mechanical anchoring phenomena and/or by the formation of physical and/or chemical bonds.

During the treatment to crosslink these resins, the latter create, by curing, a thermally stable polymeric network which traps the thermoplastic fibers so that all the problems associated with softening of these thermoplastic fibers during application of subsequent heating cycles, such as those already mentioned associated with the composite panel painting operations, disappear;

the combination of the thermoplastic textile core and the thermosetting adhesive or thermosetting adhesives provides:

good mechanical performance of the parts, especially in fatigue and in impact,

good resistance of the core at geometrical singularities during the forming.

This requires the combination of intrinsic mechanical properties of a thermoplastic polymer with those of thermosetting polymers; overall, this combination makes it possible to obtain a composite panel which is both ductile and tough.

In summary, the formable laminated composite panel according to the invention exhibits both formability and good temperature withstand behavior, compatible with the heat treatments that are applied during painting operations on formed parts.

Further advantages of the formable laminated composite panel according to the invention will become apparent on reading the examples presented below by way of nonlimiting example.

### MATERIALS

1) Sheet Metal for the Facings:

degreased galvanized steel sheets, 0.25 mm in thickness;

mechanical properties of the sheets: ES type, having a yield strength of 180 MPa;

characteristics of the galvanized coating: 10 μm per side.

2) Textile Web for the Core:

Two needle-punched textile webs were used: one supplied by Sommer (reference PR300) and the other supplied by Tharreau (reference BESTER30); these two webs were produced from polypropylene fibers.

The thickness of the two webs before impregnation was:

3 mm in the case of the PR300 web;

2.7 mm in the case of the BESTER30 web.

The mass per unit area of these two webs was 300 g/m²; the elongation at break was between 80% and 90%.

3) Thermosetting Resin:

The “one-component softened epoxy”-type resin, reference 1493 from Gurit, was used.

this resin is used for sheet-metal structural bonding applications in the automobile sector.

the main characteristics of this resin are, after being fully cured, that is to say in the thermoset state:

Young's (tensile) modulus: about 2000 MPa;

tensile elongation at break: about 14%;

glass transition temperature: about 90° C.;

percentage of mineral fillers: less than 10% (by weight).

### EXAMPLE 1

The purpose of this example is to illustrate one method of producing a formable laminated composite panel according to the invention from the components described in the above MATERIALS section.

Impregnation Step

A solution of liquid impregnation resin was prepared by diluting, when hot and with stirring, the 1493 resin in acetone.

Dilution conditions: resin/acetone ratio: 5/3; temperature: 35 to 40° C.; stirring time: between 3 and 4 hours.

Next, the textile web (see MATERIALS §, point 2) was immersed in this solution, then the impregnated web obtained was calendered between 2 rolls in order to drain this web and remove the excess impregnation solution, and then the drained web was dried between 40 and 50° C. for 15 to 30 minutes until completed evaporation of the solvent.

The drainage conditions were suitable for obtaining a ratio of the weight of impregnated textile web to the weight of 1493 impregnation resin of between 2/3 and 1.

Step of Bonding and Assembling the Composite Panel

Using a heating process, the following operations were carried out:

bringing the facing sheets into contact with each side of the preimpregnated textile core;

introducing the assembly between two heating platens;

applying a heating cycle consisting of a temperature hold for 1 hour at 160° C.; applying simple contact pressure (less than 6×10⁵ Pa) suitable for obtaining a panel whose core has a thickness of between 0.9 and 1.1 mm.

Comparative Example 1:

The purpose of this example is to prepare laminated composite panels according to the prior art, the core of which is made of a thermoplastic polymer or a thermoset and does not have a textile web.

Polypropylene (PP) Case

The sheet metal used for the facings was the same as that described in the MATERIALS section, apart from the fact that it was precoated on that side intended to come into contact with the core of a layer of adhesive having a thickness of 15 μm, based on an epoxy resin/grafted polypropylene blend.

For the core, a uniform sheet based on polypropylene with a thickness of the order of 1 mm was used.

The laminated composite panel was assembled and placed in a heating press under simple contact pressure; a heating cycle comprising a temperature hold for 2 minutes at 200° C. was then applied and the assembly left to cool down by remaining at room temperature for at least 24 hours.

Polyethylene Terephthalate (PET) Case

The sheet metal used for the facings was the same as that described in the MATERIALS section.

For the core, two homogeneous superimposed sheets based on biaxially oriented polyethylene terephthalate (PET), each having a thickness of about 0.5 mm, were used.

As adhesive between the two sheets and at the sheet/facing interfaces, the curable resin described in the MATERIALS section was used.

To manufacture the laminated composite panel:

the thermosetting resin as indicated in example 1 was diluted so as to obtain a liquid solution of this resin, or bonding solution;

a layer of the bonding solution was applied to one side of each PET sheet using a bar coater, each sheet was dried for 15 to 30 minutes between 40 and 50° C. and both sides thus coated were applied against one another;

next, a layer of the bonding solution was applied to one side of each metal sheet, which was also dried for 15 to 30 minutes between 40 and 50° C.;

the laminated composite panel was assembled and placed in a heating press under simple contact pressure; a heating cycle comprising a temperature hold for 1 hour at 160° C. was applied and the assembly left to cool down by remaining at room temperature for at least 24 hours.

All the operations of applying the bonding solution were suitable for obtaining a homogeneous bond which, after drying and crosslinking, had a uniform thickness of about 50 μm.

Polyurethane (PU) Case

The sheet metal used for the facings was the same as that described in the MATERIALS section.

For the core, a polyurethane-based adhesive, reference PLIOGRIP 7779 from Ashland, was used; to employ this adhesive, two products delivered separately, the resin and the hardener, were used; crosslinking and curing the blend of the two products were carried out at room temperature, but may be accelerated by heating.

After curing the main characteristics of the thermoset were:

Young's (tensile) modulus: about 500 MPa;

tensile elongation at break: about 75%;

glass transition temperature: about −30° C.

To manufacture the laminated composite panel:

beads of adhesive 6 mm in diameter were applied to one side of one of the facing sheets by means of a gun, the beads being placed parallel to one another with a separation of 6 mm, then calibration glass balls approximately 1 mm in diameter were placed on this side, the other facing sheet was applied to the side thus coated and the assembly obtained was pressed cold between two platens under a pressure suitable for spreading the adhesive beads until a homogeneous core, with neither pores nor cavities, was obtained;

by maintaining simple contact pressure between the platens, a heating cycle was finally applied comprising a temperature hold for 2 minutes at 200° C., and then the assembly was left to cool down by remaining at room temperature for at least 24 hours.

### EXAMPLE 2

The purpose of this example is to illustrate the drawing formability of parts obtained from composite panels according to the invention.

For the tests, laminated composite panel blanks with an outside diameter of 150 mm were prepared.

The tests used to evaluate the drawability consisted in drawing composite panel blanks of circular shape in order to give it the shape of a cup with a hemispherical bottom and in determining the maximum depth of penetration of the drawing punch, beyond which there would be damage to the panel, by the facings fracturing or by damage to the core.

For the tests, a laboratory press was used, comprising a die and a blank holder through which a punch with a hemispherical head slid:

diameter of the drawing die: 84.75 mm (with retention ring);

diameter of the punch: 75 mm;

radius of curvature at the top of the punch: 37.5 mm.

For the blank-drawing tests, the conditions applied were as follows:

blank-holder force: 80 kN; this blank-holder force made it possible to completely block the blanks and thus operate under pure expansion conditions;

drawing force: variable, between 30 and 35 kN.

Several series of tests were carried out for each type of panel blank; the average value of the maximum drawing depth values obtained was used; the average results obtained for the metal sheet alone (cf. MATERIALS, point 1), for the laminated composite panel according to the invention of example 1 and for the panels according to the prior art of comparative example 1, are given in table I.

TABLE I
Drawing formability

| | Sheet | | | | |
|---|---|---|---|---|---|
| Type of composite | metal | Example 1 | PP | PET | PU |
| panel | alone | (invention) | Case | Case | case |
| Maximum drawing | 32 | 31 | 31 | 26 | 20 |
| depth (mm) | | | | | |

It may therefore be seen that the panel according to the invention can be as easily formed as the steel sheet metals and as the laminated composite panels of the prior art which have a homogeneous polypropylene core.

### EXAMPLE 3

The purpose of this example is to illustrate the temperature withstand behavior of the drawn parts obtained from composite panels according to the invention.

The drawn test specimens of example 2 were placed for 1 hour in an oven at 200° C.; this treatment corresponds to severe conditions of baking the paint applied to automobile body parts.

The appearance of these test specimens after residing in the oven was observed.

The result of these observations demonstrate:

very good withstand of the drawn test specimens produced from the panels according to the invention of example 1 or from the panels corresponding to the “PU” case of comparative example 1: no delamination of the facings, no additional surface marking of the facings, no streaking;

poor withstand behavior of the test specimens drawn from the panels corresponding to the “PP” and “PET” cases of comparative example 1:

PP case: poor behavior resulting mainly in streaks of polypropylene polymer to the outside of the facings, especially along the edges of the parts,

PET case: poor behavior resulting in complete delamination of the two facings after 30 minutes in the oven; the PET core debonded and pushed away the two metal facings so as to resume its plane initial shape because of the internal stresses, generated during cold drawing, which had not relaxed.

In conclusion from examples 2 and 3, only the laminated composite panel according to the invention has both high formability, even under severe deformation conditions, and good temperature withstand behavior even after forming and at temperatures exceeding 160° C.

1. A formable laminated composite panel comprising two sheet metal facings joined by a core formed by at least one layer based on polymer materials, comprising at least one continuous textile web of polymer fibers which is impregnated with at least one polymer material for impregnation of the web and for adhesion to said facings, characterized in that:
said polymer fibers are thermoplastic;
said impregnation and adhesion polymer material is a thermoset.

2. The panel as claimed in claim 1, characterized in that the continuous textile web has a tensile elongation at break greater than that of the sheet metal facings.

3. The panel as claimed in claim 1 or 2, characterized in that the continuous textile web is needle-punched.

4. The panel as claimed in any one of claims 1 to 3, characterized in that said core has a uniform thickness of greater than 0.1 mm and a density greater than 0.5 kg/dm³.

5. The panel as claimed in any one of claims 1 to 4, characterized in that the weight of the impregnation thermoset represents between 30% and 70% of the total weight of the core.

6. The panel as claimed in any one of claims 1 to 5, characterized in that said facings are made of sheet steel.

7. The panel as claimed in any one of claims 1 to 6, characterized in that the thermoplastic of said fibers is chosen from the group comprising polyolefins, polyesters, polyamides, polycarbonates, polyimides, polyacrylics, polymethacrylics or polyvinyl chlorides.

8. The panel as claimed in any one of claims 1 to 7, characterized in that the impregnation and adhesion polymer material is chosen from the group comprising epoxy resins, phenolic resins, polyurethane resins, ketone-formaldehyde resins, urea resins, melamine resins, aniline resins, sulfonamide resins, alkyd resins, unsaturated polyester resins, polybutadiene resins, bismaleimide resins, polyvinyl butyral resins, isocyanate resins and polyimide resins.

9. The panel as claimed in claims 7 and 8, characterized in that the thermoplastic of said fibers is based on polypropylene and in that the impregnation and adhesion polymer material is based on an epoxy resin.

10. A process for manufacturing a formable laminated composite panel as claimed in any one of claims 1 to 9, characterized in that it comprises:
precoating one side of at least one facing made of sheet metal using a material comprising at least one thermosetting resin; then
applying the precoated side of said sheet metal against a textile web optionally preimpregnated using one or more thermosetting resins; then
applying a second sheet metal facing, optionally precoated using a material comprising at least one thermosetting resin, against the other side of said textile web; and then
a treatment for curing the thermosetting resin or resins used.

11. The use of the panel as claimed in claims 1 to 9 for the production of formed, painted and then heat-treated automobile body parts.

12. A part obtained as claimed in claim 11, characterized in that it is formed by drawing.

13. The part obtained as claimed in claim 11, characterized in that it is formed by bending.

14. The part obtained as claimed in claim 11, characterized in that it is formed by profiling.

15. The part obtained as claimed in any one of claims 11 to 14, characterized in that it is heat treated above 160° C.

16. The part as claimed in claim 15, characterized in that it is furthermore heat treated above 180° C.
